(19) United States
(12) Patent Application Publication
(10) Pub. No.: US 2008/0281011 A1
(43) Pub. Date: Nov. 13, 2008

(54) HIGH TEMPERATURE RESISTANT, STRUCTURAL POLYMER FOAM

(76) Inventor: William Strauss, Flower Mound, TX (US)

Correspondence Address: BAKER BOTTS LLP, 2001 ROSS AVENUE, 6TH FLOOR, DALLAS, TX, 75201-2980, US

(21) Appl. No.: 11/747,136

(22) Filed: May 10, 2007

(51) Int. Cl. C08J 9/35

(52) U.S. Cl. 521/122

(57) ABSTRACT

A temperature resistant, structural polymer nanocomposite foam may be formed from an amorphous or semi-crystalline, thermoplastic polymer matrix and a nano smectite clay intercalated and/or exfoliated in the polymer. The nano smectite clay may be coated with an organophilic surfactant. A polymer foam may be formed by forming a precursor material from an amorphous or semi-crystalline, thermoplastic polymer. The precursor material may be infused with a supercritical fluid at a process temperature of less than approximately 340° C. and a process pressure of at least 10 MPa. The precursor material may be foamed using the supercritical fluid by suddenly decreasing the pressure on the precursor material. The precursor material may also contain a nano smectite clay. It may be formed into a molded preform. The polymer foam formation process may include net-molding.

### TECHNICAL FIELD

Embodiments of the present invention relate to a polymer foam and methods of making such as foam. The polymer foam may be a polymer nanocomposite foam. The foam may be made using supercritical carbon dioxide (CO₂) or a similar blowing agent. The foam may be formed into a molded shape.

### TECHNICAL BACKGROUND

Foam is typically produced using one of two types of blowing agents, 1) chemical or 2) physical. Chemical blowing agents undergo a chemical reaction to produce a gas that causes foaming. Physical blowing agents are typically introduced into a precursor material, then the material is subjected to higher temperature or lower pressure to cause expansion of the blowing agent and foaming of the precursor material. Physical blowing agents typically are a gas, such as a chlorofluorocarbon, carbon dioxide, nitrogen or a gaseous hydrocarbon.

A nanocomposite is a composite mixture in which at least one of the dimensions of one of the components of the composite is in the nanometer range (10⁻⁹ m). Nanocomposites often consist of a matrix material, such as a polymer, that is reinforced by a secondary material. The secondary material, if present, may confer a beneficial property to the composite, such as increasing the rigidity of the composite. Some nanocomposites may be made into foam.

### SUMMARY

Embodiments of the invention relate to a polymer nanocomposite foam. This material may be made of an amorphous or semi-crystalline thermoplastic polymer matrix and a nano smectite clay intercalated and/or exfoliated in the polymer. In a more specific embodiment, the nano smectite clay may be coated with an organophilic surfactant.

Other embodiments of the invention relate to a method of making a polymer foam. Using such a method, a precursor material may be formed from an amorphous or semi-crystalline thermoplastic polymer. The precursor material may be infused with a supercritical fluid at a process temperature of less than approximately 340° C. and a process pressure of at least 10 MPa to create an infused precursor material. The precursor material may then be foamed using the supercritical fluid by suddenly decreasing (quenching) the pressure on the infused precursor material. In more specific embodiments, the precursor material may also contain a nano smectite clay. In another specific embodiment, it may be formed into a molded preform. In yet another specific embodiment, the polymer foam formation process may include net-molding.

### BRIEF DESCRIPTION OF THE DRAWINGS

A better understanding of the present invention will be realized from the detailed description which follows, taken in conjunction with the accompanying drawings, in which, according to embodiments of the present invention:

FIG. 1 is a flow chart showing a method of creating a polymer foam;

FIG. 2 is a scanning electron micrograph of a polyetherimide polymer foam; magnification is 49×, WD=13 mm, Vacuum Mode=High Vacuum, Chamber=4.32 e−003 Pa, Signal A=SE2, Signal B=SE2, Mixing=Off, Signal=0.8000, Stage at T=44.2°, EHT=20.00 kV;

FIG. 3 is a scanning electron micrograph of a polyetherimide/montmorillonite layered silicate nanocomposite foam; magnification is 49×, WD=9 mm, Vacuum Mode=High Vacuum, Chamber=4.94 e−003 Pa, Signal A=SE2, Signal B=InLens, Mixing=Off, Signal=1000, Stage at T=90.0°, EHT=5.00 kV, Date=Dec. 4, 2006;

FIG. 4A is a graph showing the flexural modulus of polymer foams;

FIG. 5 is a graph showing the approximate specific flexural modulus of the foams.

### DETAILED DESCRIPTION

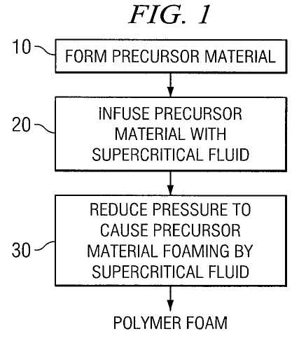

Polymer foams according to embodiments of the present inventions may be created using the example process set forth in FIG. 1. In step 10 of the process, a precursor material is formed from a polymer. In some embodiments, the precursor material may be in the shape of a molded preform. In step 20, the precursor material is infused with a supercritical fluid under high pressure. The supercritical fluid may act as both a solvent and a blowing agent. In step 30, pressure is reduced and the supercritical fluid causes foaming of the precursor material to produce a polymer foam.

Mixing of the polymer (and nano material in embodiments described further below) may be performed under a nitrogen atmosphere or other inert atmosphere to avoid oxidation.

In more specific embodiments, the polymer may be an thermoplastic polymer. Thermosetting polymers may not function as well as thermoplastic polymers in certain embodiments because the thermosetting polymer may form a network before sufficient foaming occurs.

In other embodiments, the polymer may be an amorphous polymer. Amorphous polymers may function better than polycrystalline polymers in some embodiments because the supercritical fluid may be more readily absorbed in these polymers, and amorphous polymers may exhibit better swelling during foaming.

Amorphous thermoplastics lend themselves to a physical blowing process because such a process uses semi-homogeneous diffusion of a gas into the intramolecular spaces of the polymer, as well as swelling of the polymer over a range of temperatures.

In specific embodiments, the polymer may be a thermoplastic polyimide (TPI) or polyetherimide (PEI). Examples of suitable TPI include Aurum® (Mitsui Chemicals America, Inc.) and Extem® (GE Plastics). Examples of suitable PEI include Ultem® (GE Plastics). Mixtures of suitable polymers, such as mixture of TPI and PEI, may also be used. TPI and PEI are high glass transition temperature (T_{g}) polymers that have excellent thermal, chemical and mechanical properties. Other suitable polymers include polysulfone (PSU), polyethersulfone (PES), or cyclic olefin co-polymer (COC).

In other embodiments, the polymer may be semi-crystalline. For example, it may be polyphenylene oxide (PPO).

The polymer molded preform may be created, for example, by compression molding or injection molding.

The supercritical fluid may be any fluid suitable to cause foaming, but in particular embodiments, it may be carbon dioxide (CO₂) supercritical fluid. Supercritical CO₂ is also useful because it is environmentally friendly and easily obtainable. CO₂ has a low critical point (at 31° C. and 7.376 MPA-1069.8 psi). Above the critical point, supercritical CO₂ exhibits low viscosity (like a gas) and high density (like a liquid), and acts as an efficient solvent in many polymers. The solvent effect of CO₂, particularly with TPI or PEI, may be exploited to permit processing at temperatures well below the normal processing temperatures of the polymer. CO₂ effectively lowers the processing temperature of TPI or PEI.

Without limitation to a particular mode of action, in some embodiments the CO₂ may diffuse into the polymer sample. In this process, the gas molecules may accumulate interstitially between the polymer chains, increasing the free volume and mobility of the polymer chains. In this capacity, CO₂ may act as a solvent and as such lower the T_{g} and viscosity of the precursor material. The depressed T_{g} may permit the polymer to foam at temperature far below the normal T_{g}.

In some embodiments, the supercritical fluid may lack any substantial amount of chlorofluorocarbon or gaseous hydrocarbon.

Precursor material may be prepared using a high shear melt technique. The blending of the precursor may involve mixing of the polymer with a master-batch of nano smectite dispersed in a copolymer, monomer, or oligomer selected to enhance nanocomposite properties and homogeneity. Melt blending may be performed in an inert environment to avoid oxidation of organic constituents during processing.

The temperature and pressure used after introduction of supercritical CO₂ prior to foaming may include a low temperature and a high pressure. For example, the temperature may be in a range of approximately 240° C.-340° C., particularly between 240° C. and 300° C., more particularly approximately 260° C. The pressure may be in a range of approximately 10 MPa-20 MPa, particularly 16 MPa-18 MPa.

Foam preforms of the precursor material may be formed using conventional compression molding or injection molding techniques.

When the supercritical fluid leaves the precursor material, forming a polymer foam, a skin may form. Without limitation to a particular mode of action, the supercritical fluid near the surface of the precursor material may rapidly diffuse out of the material rather than nucleating to grow foam cells. This results in the formation of a non-porous polymer skin. Within the foam a gradient of cell size can typically be seen, starting with smaller cells just under the skin and increasing to larger cells typical of the interior of the foam. When predictable and controllable, the skin effect may be desirable in some processes, such as net molding to form structural foam parts.

Without limitation to a particular mode of action, the supercritical fluid may nucleate foam cells in either a homogenous or heterogenous manner. The type of nucleation may be affected by the choice of polymer and/or supercritical fluid. For example, homogenous nucleation is typically the dominant type of nucleation when supercritical CO₂ is used at high pressures (e.g. roughly 27 MPa and above). Heterogenous nucleation can occur at much lower nucleation energies and may be stimulated by the addition of fine fillers into the polymer matrix. For example, montmorillonite (MMT) nano smectite dispersed in a polymer may cause heterogenous foam nucleation by providing numerous cites for cell formation. Nucleation may affect the type of polymer foam produced or production process parameters. Thus, the type of nucleation may be controlled to achieve desired results in either of these areas.

In general, the foaming process may be modified to achieve desired foam density and/or skin effect. The foaming process may be batch type (e.g. molded foams, free expanded loaves) or continuous (e.g. extruded, roll-to-roll).

In an alternative embodiment, the process shown in FIG. 1 may be used, but a nano material may be added to the precursor material in step 10. In more specific embodiments, the nano material may be exfoliated or intercalated layers of expandable smectite clays, such as a 2:1 phyllosilicate smectite (e.g. montmorillonite or other sodium, calcium, aluminum silicates). In particular, the nano material may be MMT such as Cloisite Na+ (Southern Clay Products). The nano material, such as MMT, may be present in an amount of between 0 to 5% by weight.

The nano material may be treated to facilitate formation and/or stability of the polymer nanocomposite foam. For example, the nano material may be surfactant-treated montmorillonite. The surfactant may be an organophilic surfactant such as an aliphatic amine, zirconate, titanate, silane, dodecyltrimethyl ammonium (DTA), hexadecylamine, aminophenobenzene, alkylammonium salt, alkylphosphonium salt, or similar compound such as other cationic surfactants with aliphatic tails. In one embodiment, the surfactant may be zirconte NZ44 (Kenrich Petrochemicals).

Smectite clays in particular may benefit from surfactant treatment because they are naturally hydrophilic and thus do not tend to blend stably with organic polymers. Surfactant treatment may render these clays organophilic. In particular, the choice of surfactant may depend on one or more of the following factors: affinity with the desired polymer matrix, effectiveness as an exfoliating agent, and thermal stability.

The nano material may be selected to have a particular shape and/or physical properties. For example, MMT reinforces the polymer nanocomposite foam in part because it is in the form of platelets having a high aspect ratio on average (1000:1, as calculated by dividing platelet length by thickness). As a result, polymer foams reinforced with even low weight percentages of MLS (e.g. less than 9% by weight) may exhibit significant increases in mechanical properties such as tensile strength, modulus, and impact strength.

The nano material may be dispersed in the polymer via a solvent, thermomechanical methods, or in situ polymerization. Heat and shear typically help with dispersion of any type. The nanomaterial may be suitably dispersed through exfoliation, intercalation or a combination of the two.

The foams in FIGS. 2-5 were prepared using pelletised Ultem® 1000 from GE Plastics. MMT used was Cloisite NA+ from Southern Clay Products. Surfactant was NZ44 from Kenrich Petrochemicals. Industrial 99.99% pure CO₂ was used. The MMT was treated with 4% (by weight) surfactant in a Henschel mixer. Polymer pellets and treated nanoclay were dried in a convection oven prior to compounding. Pre-weighed samples of polymer and 3% (by weight) treated nanoclay were mixed in a heated batch mixer at 320° C. and 25 rpm for 4 minutes. The mixture was then compression molded into laminates in a heated platen press at 350° C. and approximately 150 psi for 5 minutes prior to cooling. The laminates were approximately 1 mm thick. Samples containing no nanoclay were also prepared in a similar fashion.

To foam the materials, a pressure chamber was cooled to approximately 10° C. The sample was placed in the chamber and the chamber was pressurized with liquid/gas CO₂ to approximately 5-6 MPA. The reactor was heated to a process temperature of approximately 250° C., 260° C., 270° C. or 280° C. at a rate of approximately 2° C. per minute. The pressure increased isochorically during this process. Pressure was relieved periodically to remain below approximately 18 MPa. Pressure was typically approximately 17 MPa-18 MPa. The samples were then soaked for approximately 30 minutes at process temperature and pressure. The chamber was then rapidly vented (quenched) to atmospheric pressure in less than approximately 5 seconds to generate foam. The chamber was cooled to RT and the foamed sample was removed. The samples tested in FIGS. 2-5 were thus obtained.

The above process, when used with PEI as the polymer, showed that a low processing temperature and short soak times may be used. Process temperature had the greatest effect on foam morphology of all process parameters.

All samples produced using this process had a skin, but MLS samples tended to have a thicker, denser skin. Use of a polymer less permeable to CO₂ than TPI or PEI may result in a thinner skin.

Alternatively, a two-step process may be used in which the saturated polymer is temperature and pressure quenched in a constrained state, followed by foam expansion in a heated bath. This two-step process may be the sort commonly used in commercial batch foam manufacturing.

Further, although the above process worked well for PEI-based foams, variations may produce a better foam for TPI. In particular, TPI may revert to a polycrystalline form at temperatures above T_{g}, indicating a different process temperature may be beneficial when using TPI.

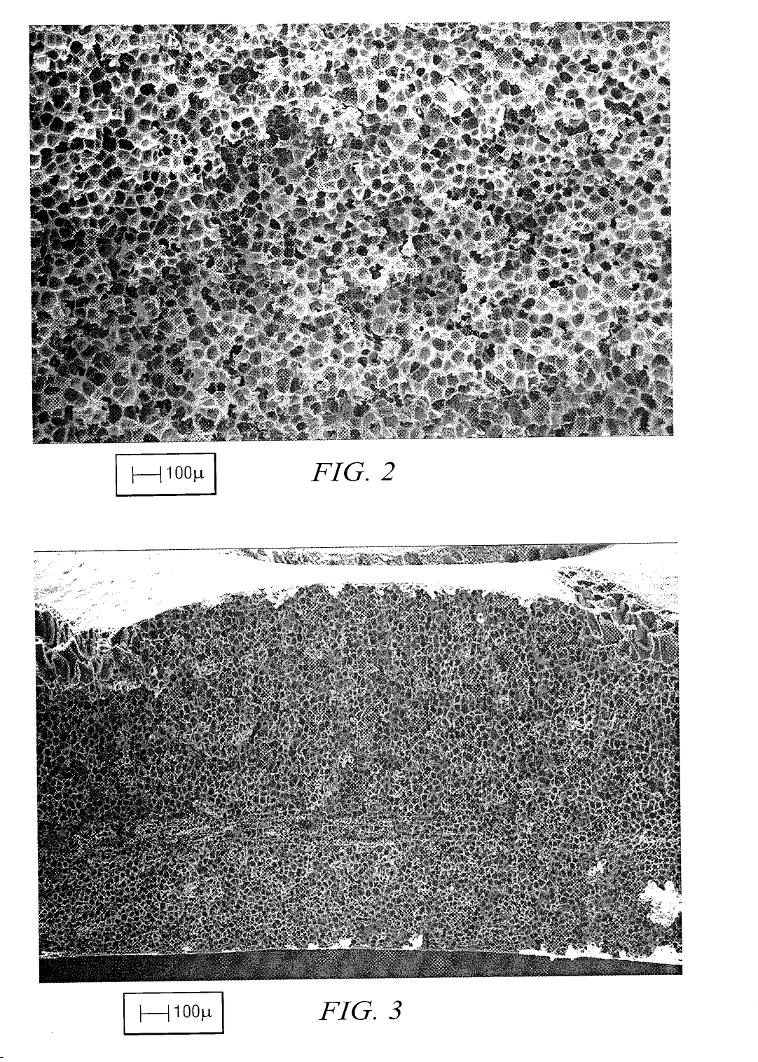

Other embodiments of the invention relate to moldable expanded polymer foams, including polymer nanocomposite foams. The polymer nanocomposite foams may include a polymer matrix, a nano material intercalated or exfoliated in the polymer matrix, and optionally a surfactant on the clay. An example polymer foam created using PEI and supercritical CO₂ in the above processes is show in FIG. 2. An example polymer nanocomposite foam created using PEI, MLS and supercritical CO₂ in the above process is shown in FIG. 3. In general, polymer foams (including polymer nanocomposite foams) described herein may have one or more of the following properties: lightweight, low dielectric constant, high specific strength, low thermal conductivity, temperature resistance, flame retardance, and net-moldability. Polymer nanocomposite foams may have much better mechanical properties than traditional moldable expanded foams, while maintaining or even improving the other beneficial properties of those foams.

As FIGS. 2 and 3 show, the addition of nanocomposite to the polymer foam causes the formation of smaller cell sizes. To obtain FIGS. 2 and 3, foamed samples were scored and fractured at room temperature or in liquid nitrogen as required. The fractured sample faces were sputter-coated with iridium coating to prevent surface charging. Foam cross sections were analyzed for cell type, size and shape. Individual cells were examined for evidence of grain structure and orientation. Measurements were taken on an LEO 1550VP field emission scanning electron microscope.

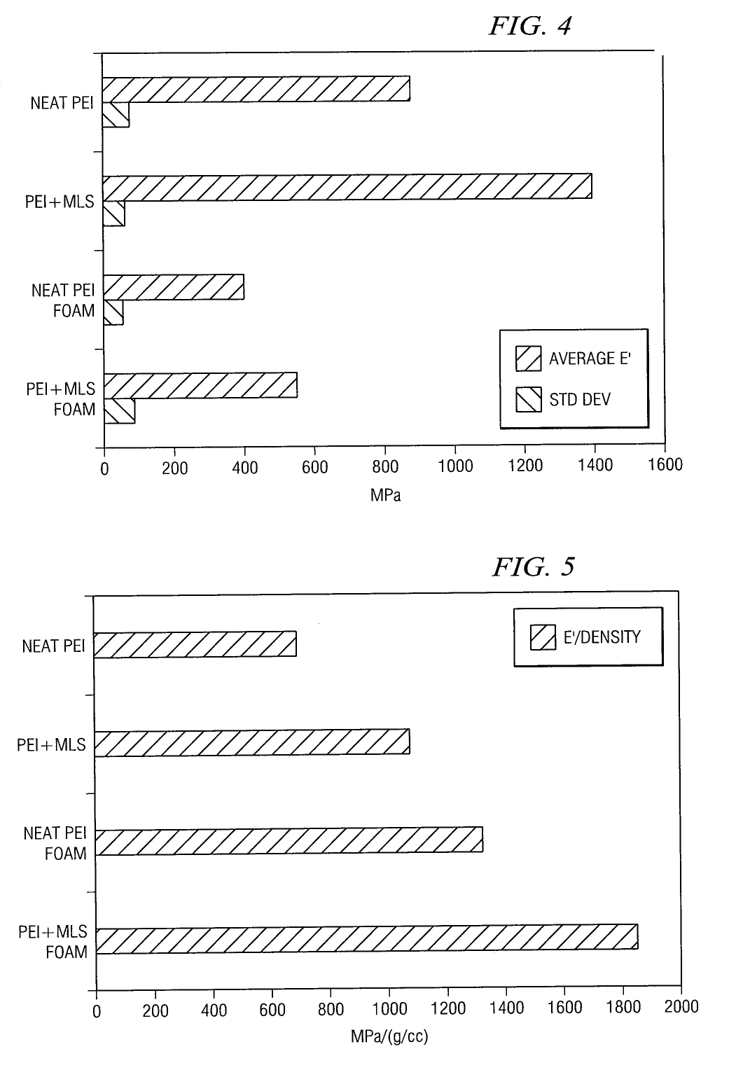

The nanocomposite material also provides higher strength and improved stability at higher temperatures as compared to polymer foam alone. Mechanical testing is shown in FIG. 4. For mechanical testing, foamed and unfoamed samples were tested by three point bening (10 mm span) to determine the effects of MLS concentration on mechanical properties. Measurements were taken on a dynamic mechanical analyzer (DMA) RSA3 (TA Instruments). As FIG. 4A shows, both PEI polymer foam and PEI/MLS polymer nanocomposite foam show an improved flexural modulus as compared to unfoamed precursor material. FIG. 5 shows that PEI/MLS polymer nanocomposite foam, in particular, shows a greatly improved specific flexural modulus.

Polymer foams, particularly polymer nanocomposite foams of the present invention, including those specifically described above, may be used in a variety of applications. For example, the foams may be used in structures having a high strength to weight ratio (e.g. nonmetallic honeycombs), chemical and vapor barrier materials (e.g. low-permeability packaging), tuned dielectric materials (e.g. low dielectric materials in radomes low observable RF systems, and other electronics), and in other applications benefiting from tailored physical and/or mechanical properties. In particular, the polymer foams or polymer nanocomposite foams may be designed to be high T_{g}, low density, high stiffness materials. They may be used as net molded products, as structural sandwich cores, or as other low-density core materials.

Polymer foams and polymer nanocomposite foams may be particularly useful as components of devices in the aerospace industry and the RF antenna industry. For example, the foams may be used in low RF radomes having complex core shapes, airfoil leading edge apertures with low dielectric and high strength/stiffness, lightweight radomes with good performance at high temperatures, and aerospace structures or enclosures having low smoke or toxicity indices.

Although only exemplary embodiments of the invention are specifically described above, it will be appreciated that modifications and variations of these examples are possible without departing from the spirit and intended scope of the invention.

1. A polymer nanocomposite foam comprising:
an amorphous or semi-crystalline, thermoplastic polymer matrix; and
a nano smectite clay intercalated and/or exfoliated in the polymer.

2. The polymer nanocomposite foam of claim 1, further comprising an organophilic surfactant on the nano smectite clay.

3. The polymer nanocomposite foam of claim 1, wherein the amorphous or semi-crystalline, thermoplastic polymer matrix comprises polyetherimide.

4. The polymer nanocomposite of claim 1, wherein the amorphous or semi-crystalline, thermoplastic polymer matrix comprises thermoplastic polyimide.

5. The polymer nanocomposite foam of claim 1, wherein the nano smectite clay comprises a 2:1 phyllosilicate smectite.

6. The polymer nanocomposite foam of claim 1, wherein the nano smectite clay comprises montmorillonite.

7. The polymer nanocomposite foam of claim 2, wherein the organophilic surfactant is selected from the group consisting of: aliphatic amines, zirconates, titanates, silanes, dodecyltrimethyl ammonium (DTA), hexadecylamine, or aminophenobenzene, alkylammonium salts, alkylphosphonium salts, and combinations thereof.

8. A method of making a polymer foam comprising:
forming a precursor material from an amorphous or semi-crystalline, thermoplastic polymer;
infusing the precursor material with a supercritical fluid at a process temperature of less than approximately 340° C. and a process pressure of at least 10 MPa to create an infused precursor material;
foaming the precursor material using the supercritical fluid as a physical blowing agent by suddenly decreasing the pressure on the infused precursor material.

9. The method of claim 8, further comprising forming the precursor material from an amorphous or semi-crystalline, thermoplastic polymer and a nano smectite clay.

10. The method of claim 9, wherein the nano smectite clay comprises a 2:1 phyllosilicate smectite.

11. The method of claim 9, wherein the nano smectite clay comprises montmorillonite.

12. The method of claim 9, wherein the nano smectite clay has been treated with an organophilic surfactant.

13. The method of claim 8, wherein the amorphous or semi-crystalline, thermoplastic polymer matrix comprises polyetherimide.

14. The method of claim 8, wherein the amorphous or semi-crystalline, thermoplastic polymer matrix comprises thermoplastic polyimide.

15. The method of claim 8, comprising forming a molded preform from the precursor material.

16. The method of claim 8, wherein the supercritical fluid comprises supercritical carbon dioxide.

17. The method of claim 8, wherein the process temperature is between approximately 240° C. and 340° C.

18. The method of claim 8, wherein the process pressure is between approximately 10 MPa and 20 MPa.

19. The method of claim 8, further comprising net-molding the polymer foam.

20. The method of claim 8, wherein foaming comprises decreasing pressure to approximately atmospheric pressure.
